(19) United States
(12) Patent Application Publication
(10) Pub. No.: US 2007/0222354 A1
(43) Pub. Date: Sep. 27, 2007

(54) CARBON NANOTUBE FIELD EMITTING DISPLAY

(76) Inventor: Ming-Ru Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,960

(22) Filed: May 30, 2006

(30) Foreign Application Priority Data
Mar. 23, 2006 (TW) 95110009

(51) Int. Cl. H01J 1/00

(52) U.S. Cl. 313/311; 313/496

(57) ABSTRACT

A carbon nanotube field emitting display including a cathode substrate and an anode substrate is provided. The anode substrate is disposed on the cathode substrate and includes a first substrate, a fluorescence material layer, an anode electrode and a plurality of color filter membranes. The first substrate has a first surface and a second surface, and the first surface faces the cathode substrate. The anode electrode is disposed on the first surface of the first substrate. The fluorescence material layer is disposed between the anode electrode and the cathode substrate. The color filter membranes are disposed between the fluorescence material layer and the first substrate or on the second surface of the first substrate. As described above, a carbon nanotube field emitting display with better display quality is provided.

### CROSS-REFERENCE TO RELATED APPLICATION

This application claims the priority benefit of Taiwan application serial no. 95110009, filed on Mar. 23, 2006. All disclosure of the Taiwan application is incorporated herein by reference.

### BACKGROUND OF THE INVENTION

1. Field of Invention

The present invention relates to a display. More particularly, the present invention relates to a carbon nanotube field emitting display (CNT-FED).

2. Description of Related Art

Due to its advantages such as lightness, low power consumption, and no visual angle difference, the field emitting display is the most researched display. The light emitting theory of a field emitting display is that in vacuum environment, electrons are dissociated from the end of the material through intensified electric field, and then the field emitted electrons leaving the cathode substrate are accelerated by the positive voltage of the anode substrate to collide with the fluorescence material on the anode substrate so as to emit luminescence. That is, the cathode substrate is used as the field electron emitting source, the anode substrate is used as the light emitting source, and the electrons emitted by the cathode substrate collide with the fluorescence layer on the anode substrate to emit luminescence.

FIG. 1 is a diagram illustrating the structure of a conventional carbon nanotube field emitting display (CNT-FED). Referring to FIG. 1, the conventional CNT-FED 30 includes a cathode substrate 10 and an anode substrate 20. There are a plurality of cathode lines 12, a plurality of carbon nanotubes 13, and a plurality of gate lines 14 on the lower substrate 11 of the cathode substrate 10. The carbon nanotubes 13 are disposed on the cathode lines 12 and each carbon nanotube 13 is electrically connected to the corresponding cathode line 12. The gate lines 14 and the cathode lines 12 are arranged in a staggered way, each gate line 14 has a plurality of openings 14a, and each opening 14a exposes one of the carbon nanotubes 13.

There are an anode electrode 22, a plurality of red fluorescence patterns 23r, a plurality of green fluorescence patterns 23g, and a plurality of blue fluorescence patterns 23b on the upper substrate 21 of the anode substrate 20. The red fluorescence patterns 23r, the green fluorescence patterns 23g, and the blue fluorescence patterns 23b are disposed on the anode electrode 22.

In the CNT-FED 30, the electrons are accelerated by the positive voltage of the anode electrode 22 and are emitted towards the red fluorescence patterns 23r, the green fluorescence patterns 23g, and the blue fluorescence patterns 23b after the electrons are dissociated from the carbon nanotubes 13. The red fluorescence patterns 23r, the green fluorescence patterns 23g, and the blue fluorescence patterns 23b emit red light, green light, and blue light after the electrons collide with the red fluorescence patterns 23r, the green fluorescence patterns 23g, and the blue fluorescence patterns 23b. The CNT-FED 30 displays images if suitable voltage signals are supplied to the cathode lines 12, the gate lines 14, and the anode electrode 22.

However, the position of a part of the red fluorescence patterns 23r, the green fluorescence patterns 23g, and the blue fluorescence patterns 23b may be shifted while forming the red fluorescence patterns 23r, the green fluorescence patterns 23g, and the blue fluorescence patterns 23b of the anode substrate 20. Such shift is easily induced in the fabrication process of large size displays. When the shift of a particular area is too large, the red fluorescence patterns 23r, the green fluorescence patterns 23g, and the blue fluorescence patterns 23b will greatly depart from the predetermined position. The electron beam originally only colliding with the red fluorescence patterns 23r may collide with the green fluorescence patterns 23g after forming the CNT-FED 30 with the cathode substrate 10 and the anode substrate 20, which results in both red light and green light being emitted at the same time, accordingly the display quality of the CNT-FED 30 is reduced.

### SUMMARY OF THE INVENTION

Accordingly, the present invention is directed to provide a carbon nanotube field emitting display (CNT-FED) with better display quality.

To achieve the aforementioned and other objectives, the present invention provides a CNT-FED, which includes a cathode substrate and an anode substrate. The anode substrate is disposed on the cathode substrate and includes a first substrate, an anode electrode, a fluorescence material layer, and a plurality of color filter membranes. The first substrate has a first surface and a second surface, and the first surface faces the cathode substrate. The anode electrode is disposed on the first surface of the first substrate. The fluorescence material layer is disposed between the anode electrode and the cathode substrate. The color filter membranes are disposed between the fluorescence material layer and the first substrate or on the second surface of the first substrate.

According to the CNT-FED in an embodiment of the present invention, the color filter membranes are disposed between the fluorescence material layer and the anode electrode.

According to the CNT-FED in an embodiment of the present invention, the color filter membranes are disposed between the anode electrode and the first substrate.

According to the CNT-FED in an embodiment of the present invention, the color filter membranes include red filter membranes, green filter membranes, and blue filter membranes.

According to the CNT-FED in an embodiment of the present invention, the anode substrate further includes a black matrix layer disposed between the color filter membranes, and the color filter membranes partially cover the black matrix layer.

According to the CNT-FED in an embodiment of the present invention, the cathode substrate includes a second substrate, a plurality of cathode lines, a plurality of field emitting devices, and a plurality of gate lines. The cathode lines are disposed on the second substrate. The field emitting devices are disposed on the second substrate, and each field emitting device is electrically connected to one of the cathode lines. The gate lines are disposed over the cathode lines, each gate line has a plurality of openings, and each opening exposes one of the field emitting devices. Each field emitting device corresponds to one of the color filter membranes.

According to the CNT-FED in an embodiment of the present invention, the foregoing field emitting devices include carbon nanotubes.

According to the CNT-FED in an embodiment of the present invention, the foregoing cathode substrate further includes an insulating layer disposed between the cathode lines and the gate lines, and the openings of the gate lines further extend to the insulating layer for exposing the field emitting devices.

According to the CNT-FED in an embodiment of the present invention, the material of the foregoing insulating layer includes glass.

According to the CNT-FED in an embodiment of the present invention, the cathode substrate includes a second substrate, a plurality of cathode lines, a plurality of gate lines, a plurality of active components, and a plurality of field emitting devices. The cathode lines, the gate lines, and the active components are all disposed on the second substrate, and each active component is electrically connected to one of the cathode lines and one of the gate lines. The field emitting devices are disposed on the second substrate, each field emitting device is electrically connected to one of the active components, and each field emitting device corresponds to one of the color filter membranes.

According to the CNT-FED in an embodiment of the present invention, the foregoing field emitting devices include carbon nanotubes.

According to the CNT-FED in an embodiment of the present invention, the foregoing cathode substrate further includes an insulating layer which covers the cathode lines, the gate lines, and the active components, and the field emitting devices are disposed on the insulating layer.

According to the CNT-FED in an embodiment of the present invention, the material of the foregoing insulating layer includes glass.

According to an embodiment of the present invention, the CNT-FED further includes a plurality of spacers disposed between the cathode substrate and the anode substrate.

According to the CNT-FED in an embodiment of the present invention, the material of the anode electrode includes Indium Tin Oxide (ITO), Indium Zinc Oxide (IZO), or other transparent conductive materials.

According to the CNT-FED in an embodiment of the present invention, the material of the fluorescence material layer includes white light fluorescence material.

According to the CNT-FED in an embodiment of the present invention, the distance between the anode substrate and the cathode substrate is between 1 mm and 50 mm. In another embodiment, the distance between the anode substrate and the cathode substrate is between 1 mm and 5 mm.

In the CNT-FED provided by the present invention, the fluorescence material layer is a single structure layer, so that the problem of departing from predetermined position will not be induced when forming the fluorescence material layer. Thus, in the CNT-FED of the present invention, the electron beam emitted from the same field emitting device does not produce lights of two different colors. In other words, the CNT-FED in the present invention has better display quality.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the structure of a conventional carbon nanotube field emitting display (CNT-FED).

FIG. 2A is a cross-sectional view illustrating the structure of a CNT-FED according to the first embodiment of the present invention.

FIG. 2B is a partial top view illustrating the cathode substrate of the CNT-FED in FIG. 2A.

FIG. 2C is a cross-sectional view illustrating the structure of a CNT-FED according to another embodiment of the present invention.

FIG. 3A is a cross-sectional view illustrating the structure of a CNT-FED according to the second embodiment of the present invention.

FIG. 3B is a partial top view illustrating the cathode substrate of the CNT-FED in FIG. 3A.

FIG. 4A is a cross-sectional view illustrating the structure of a CNT-FED according to the third embodiment of the present invention.

FIG. 4B is a partial top view illustrating the cathode substrate of the CNT-FED in FIG. 4A.

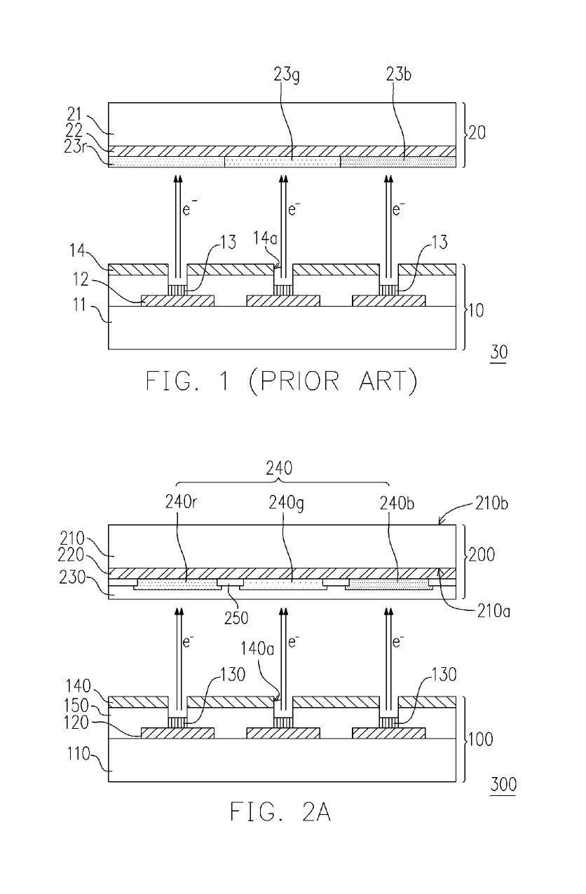

### DESCRIPTION OF EMBODIMENTS

### First Embodiment

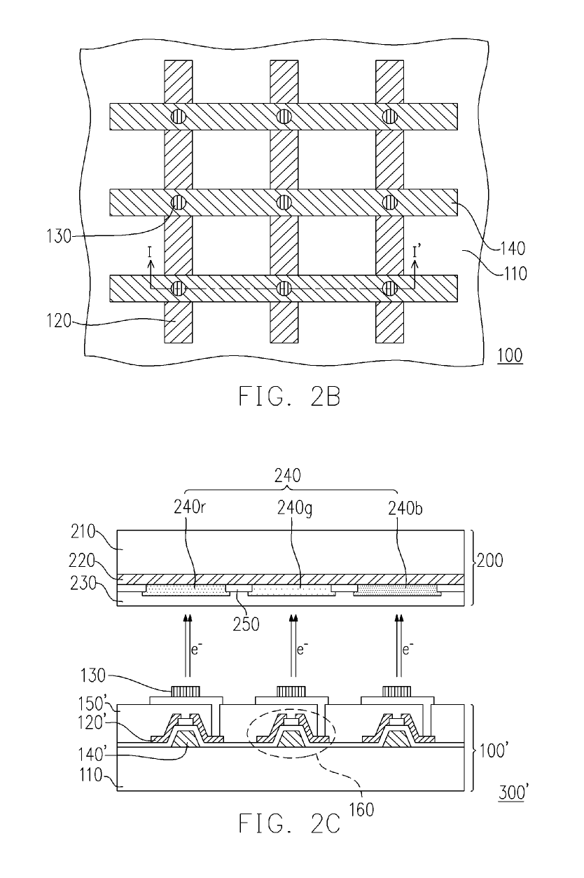

FIG. 2A is a cross-sectional view illustrating the structure of a CNT-FED according to the first embodiment of the present invention, and FIG. 2B is a partial top view illustrating the cathode substrate of the CNT-FED in FIG. 2A. Wherein, the cathode substrate in FIG. 2A is the cross-sectional view of FIG. 2B cut along line I-I′. Referring to both FIG. 2A and FIG. 2B, the CNT-FED 300 includes a cathode substrate 100 and an anode substrate 200. The anode substrate 200 is disposed on the cathode substrate 100 and includes a first substrate 210, an anode electrode 220, a fluorescence material layer 230, and a plurality of color filter membranes 240. The first substrate 210 has a first surface 210a and a second surface 210b, and the first surface 210a faces the cathode substrate 100. The anode electrode 220 is disposed on the first surface 210a of the first substrate 210. The fluorescence material layer 230 is disposed between the anode electrode 220 and the cathode substrate 100. The color filter membranes 240 are disposed between the fluorescence material layer 230 and the first substrate 210 or on the second surface 210b of the first substrate 210.

In the present embodiment, the color filter membranes 240 are disposed between the fluorescence material layer 230 and the anode electrode 220. The color filter membranes 240 include red filter membranes 240r, green filter membranes 240g, and blue filter membranes 240b. Moreover, the anode substrate 200 further includes a black matrix layer 250 disposed between the red filter membranes 240r, the green filter membranes 240g, and the blue filter membranes 240b; and the red filter membranes 240r, the green filter membranes 240g, and the blue filter membranes 240b partially cover the black matrix layer 250.

In particular, the cathode substrate 100 includes a second substrate 110, a plurality of cathode lines 120, a plurality of field emitting devices 130, and a plurality of gate lines 140. The cathode lines 120 are disposed on the second substrate 110. The field emitting devices 130 are disposed on the second substrate 110, and each field emitting device 130 is electrically connected to one of the cathode lines 120. The gate lines 140 are disposed over the cathode lines 120, each gate line has a plurality of openings 140a, and each opening 140a exposes one of the field emitting devices 130. Each field emitting device 130 corresponds to one of the red filter membranes 240r, the green filter membranes 240g, and the blue filter membranes 240b. Moreover, the cathode substrate 100 further includes an insulating layer 150 disposed between the cathode lines 120 and the gate lines 140, and the openings 140a of the gate lines 140 further extend to the insulating layer 150 for exposing the field emitting devices 130.

Besides the components described above, the CNT-FED 300 in the present embodiment further includes a plurality of spacers (not shown) disposed between the cathode substrate 100 and the anode substrate 200.

As described above, the distance between the anode substrate 200 and the cathode substrate 100 is, for example, between 1 mm and 50 mm, or for better result, between 1 mm and 5 mm. The second substrate 110 is, for example, glass substrate, silicon substrate, or substrate of other suitable material, and the second substrate 110 may be transparent or nontransparent substrate. The material of the cathode lines 120 is, for example, silver (Ag) or other suitable material. The field emitting devices 130 are, for example, carbon nanotubes or other suitable devices. The material of the gate lines 140 is, for example, silver or other suitable material. The material of the insulating layer 150 is, for example, glass or other suitable material. The first substrate 210 is, for example, glass substrate, silicon substrate, or transparent substrate of other suitable material. The material of the anode electrode 220 is, for example, Indium Tin Oxide (ITO), Indium Zinc Oxide (IZO), or other transparent conductive material. The material of the fluorescence material layer 230 is, for example, white light fluorescence material or other suitable fluorescence material.

If suitable voltage signals are supplied to the cathode lines 120, the gate lines 140, and the anode electrode 220, electrons will be dissociated from various field emitting devices 130 and accelerated by the positive voltage of the anode electrode 220 to be emitted towards the fluorescence material layer 230. The fluorescence material layer 230 emits white light when the electrons collide with the fluorescence material layer 230. Red light, green light, or blue light are formed after the white light is filtered by the red filter membranes 240r, the green filter membranes 240g, or the blue filter membranes 240b. Accordingly, the CNT-FED 300 can display the image.

It should be noted that the aforementioned first substrate 210, the anode electrode 220, and the color filter membranes 240 form a color filter substrate (not shown). The anode substrate 200 can be formed after the fluorescence material layer 230 is formed on the color filter substrate. The problem of departing from predetermined position in the conventional technology will not be induced when forming the fluorescence material layer 230 since the fluorescence material layer 230 is a single structure layer. Thus, the electron beam emitted from the same field emitting device 130 will not produce lights of two different colors. In other words, the CNT-FED 300 has better display quality.

It should be noted that the cathode substrate 100 in the present embodiment is not limited to the structure described above. For example, in another embodiment as illustrated in FIG. 2C, the cathode substrate 100′ of the CNT-FED 300′ is an active device array substrate. The cathode substrate 100′ includes a second substrate 110, a plurality of cathode lines 120′, a plurality of gate lines 140′, an insulating layer 150′, a plurality of active devices 160, and a plurality of field emitting devices 130.

The cathode lines 120′, the gate lines 140′, the active devices 160, and the field emitting devices 130 are all disposed on the second substrate 110. Each active device 160 is electrically connected to one of the cathode lines 120′ and one of the gate lines 140′. Each field emitting device 130 is electrically connected to one of the active devices 160, and each field emitting device 130 corresponds to one of the color filter membranes 240. The insulating layer 150′ covers the cathode lines 120′, the gate lines 140′, and the active devices 160. The field emitting devices 130 are disposed on the insulating layer 150′. The material of the cathode lines 120′ and the gate lines 140′ is, for example, suitable conductive material. The material of the insulating layer 150′ is, for example, glass or other suitable material. The active devices 160 are, for example, thin film transistors (TFT) or other switching devices with three terminals.

### Second Embodiment

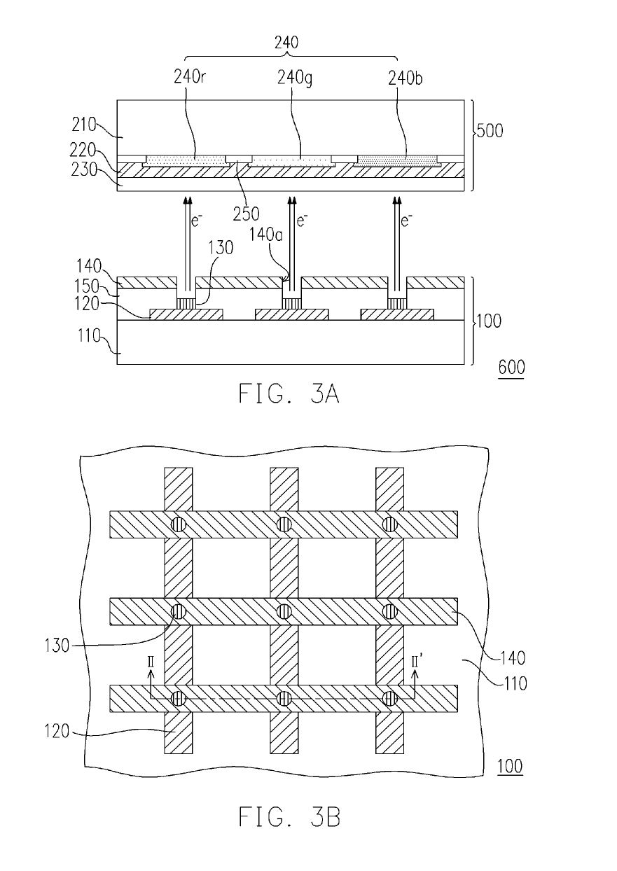

FIG. 3A is a cross-sectional view illustrating the structure of a CNT-FED according to the second embodiment of the present invention, and FIG. 3B is a partial top view illustrating the cathode substrate of the CNT-FED in FIG. 3A. Wherein, the cathode substrate in FIG. 3A is the cross-sectional view of FIG. 3B cut along line II-II′. Referring to both FIG. 3A and FIG. 3B, the CNT-FED 600 in the present embodiment is similar to the CNT-FED 300 in the first embodiment, and the difference is that in the anode substrate 500 of the CNT-FED 600, the color filter membranes 240 are disposed between the anode electrode 220 and the first substrate 210.

The CNT-FED 600 has the same advantages as those described in the first embodiment, so the details will not be described here again.

### Third Embodiment

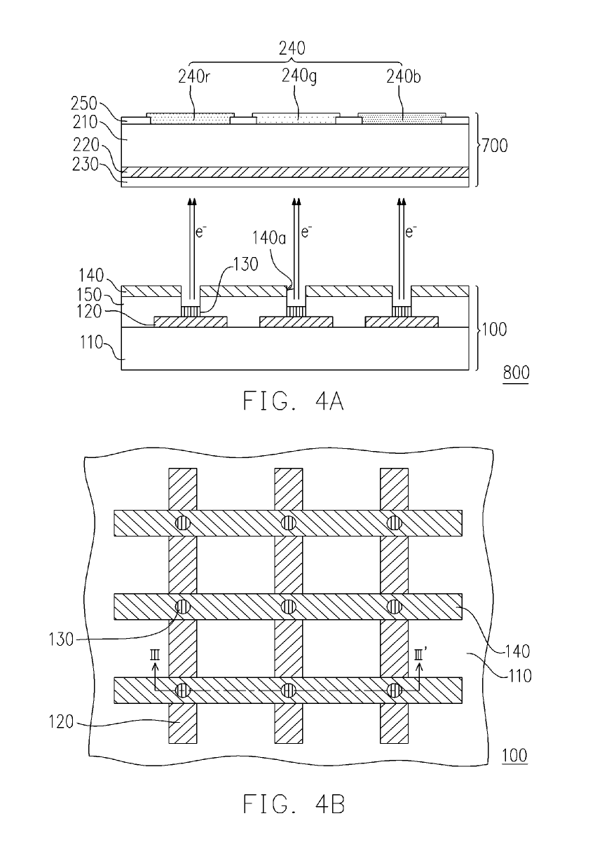

FIG. 4A is a cross-sectional view illustrating the structure of a CNT-FED according to the third embodiment of the present invention, and FIG. 4B is a partial top view illustrating the cathode substrate of the CNT-FED in FIG. 4A. Wherein, the cathode substrate in FIG. 4A is the cross-sectional view of FIG. 4B cut along line III-III′. Referring to both FIG. 4A and FIG. 4B, the CNT-FED 800 in the present embodiment is similar to the CNT-FED 300 in the first embodiment, and the difference is that in the anode substrate 700 of the CNT-FED 800, the color filter membranes 240 are disposed on the second surface of the first substrate 210, and meanwhile, the first substrate 210 can be formed by stacking two substrates back to back.

The CNT-FED 800 has the same advantages as those described in the first embodiment, so the details will not be described here again.

In overview, the CNT-FED in the present invention has at least the following advantages:

1. In the CNT-FED of the present invention, the fluorescence material layer has single layer structure, so that the problem of departing from predetermined position will not be induced when forming the fluorescence material layer. Moreover, in the CNT-FED of the present invention, the electron beams emitted from the same field emitting device will not produce lights of two different colors, so that the CNT-FED in the present invention has better display quality.

2. In the CNT-FED of the present invention, the fabrication process of the anode substrate is simple since only a fluorescence material layer is to be formed on the color filter substrate. Thus, the CNT-FED in the present invention has lower manufacturing cost and can be easily mass produced.

3. The CNT-FED in the present invention is more competitive on the market for it has lower manufacturing cost and can be easily mass produced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A carbon nanotube field emitting display, comprising:
a cathode substrate; and
an anode substrate, disposed on the cathode substrate, the anode substrate comprising:
a first substrate, having a first surface and a second surface, the first surface facing the cathode substrate;
an anode electrode, disposed on the first surface of the first substrate;
a fluorescence material layer, disposed between the anode electrode and the cathode substrate;
a plurality of color filter membranes, disposed between the fluorescence material layer and the first substrate or on the second surface of the first substrate.

2. The carbon nanotube field emitting display as claimed in claim 1, wherein the color filter membranes are disposed between the fluorescence material layer and the anode electrode.

3. The carbon nanotube field emitting display as claimed in claim 1, wherein the color filter membranes are disposed between the anode electrode and the first substrate.

4. The carbon nanotube field emitting display as claimed in claim 1, wherein the color filter membranes include red filter membranes, green filter membranes, and blue filter membranes.

5. The carbon nanotube field emitting display as claimed in claim 1, wherein the anode substrate further comprises a black matrix layer disposed between the color filter membranes, and the color filter membranes partially cover the black matrix layer.

6. The carbon nanotube field emitting display as claimed in claim 1, wherein the cathode substrate comprises:
a second substrate;
a plurality of cathode lines, disposed on the second substrate;
a plurality of field emitting devices, disposed on the second substrate, each field emitting device being electrically connected to one of the cathode lines;
a plurality of gate lines, disposed over the cathode lines, each gate line having a plurality of openings, each opening exposing one of the field emitting devices, each field emitting device corresponding to one of the color filter membranes.

7. The carbon nanotube field emitting display as claimed in claim 6, wherein the field emitting devices include carbon nanotubes.

8. The carbon nanotube field emitting display as claimed in claim 6, wherein the cathode substrate further comprises an insulating layer disposed between the cathode lines and the gate lines, and the openings of the gate lines further extend to the insulating layer for exposing the field emitting devices.

9. The carbon nanotube field emitting display as claimed in claim 8, wherein the material of the insulating layer includes glass.

10. The carbon nanotube field emitting display as claimed in claim 1, wherein the cathode substrate comprises:
a second substrate;
a plurality of cathode lines, disposed on the second substrate;
a plurality of gate lines, disposed on the second substrate;
a plurality of active components, disposed on the second substrate, each active component being electrically connected to one of the cathode lines and one of the gate lines;
a plurality of field emitting devices, disposed on the second substrate, each field emitting device being electrically connected to one of the active components, each field emitting device corresponding to one of the color filter membranes.

11. The carbon nanotube field emitting display as claimed in claim 10, wherein the field emitting devices include carbon nanotubes.

12. The carbon nanotube field emitting display as claimed in claim 10, wherein the cathode substrate further comprises an insulating layer covering the cathode lines, the gate lines, and the active components, and the field emitting devices are disposed on the insulating layer.

13. The carbon nanotube field emitting display as claimed in claim 12, wherein the material of the insulating layer includes glass.

14. The carbon nanotube field emitting display as claimed in claim 1 further comprising a plurality of spacers disposed between the cathode substrate and the anode substrate.

15. The carbon nanotube field emitting display as claimed in claim 1, wherein the material of the anode electrode includes Indium Tin Oxide (ITO), Indium Zinc Oxide (IZO), or other transparent conductive materials.

16. The carbon nanotube field emitting display as claimed in claim 1, wherein the material of the fluorescence material layer includes white light fluorescence material.

17. The carbon nanotube field emitting display as claimed in claim 1, wherein the distance between the anode substrate and the cathode substrate is between 1 mm and 50 mm.

18. The carbon nanotube field emitting display as claimed in claim 17, wherein the distance between the anode substrate and the cathode substrate is between 1 mm and 5 mm.
